(19) United States
(12) Patent Application Publication
(10) Pub. No.: US 2026/0266186 A1
(43) Pub. Date: Sep. 10, 2026

(54) COMPOSITE BLADE

(71) Applicant: IHI Corporation, Tokyo (JP)

(72) Inventors: Kazuya HANDA, Tokyo (JP); Kimitoshi NAKAMURA, Tokyo (JP); Rintarou KAJIWARA, Tokyo (JP); Takaomi INADA, Tokyo (JP)

(73) Assignee: IHI Corporation, Tokyo (JP)

(21) Appl. No.: 19/658,951

(22) Filed: Apr. 27, 2026

Related U.S. Application Data
(63) Continuation of application No. PCT/JP2024/027566, filed on Aug. 1, 2024.

(30) Foreign Application Priority Data
Nov. 21, 2023 (JP) 2023-197277

(51) Int. Cl. F01D 5/28

(52) U.S. Cl. CPC F01D 5/282; F05D 2300/6034

(57) ABSTRACT

A composite blade includes: composite plies laminated in the blade thickness direction, having a predetermined orientation angles with respect to the span direction, and constituting an airfoil section of the composite blade, wherein an outer layer section located on an outer layer side of the airfoil section is divided into a first region and a second region arranged in the span direction; the composite plies include: first outer plies laminated in the first region, second outer plies laminated in the second region, and inner plies laminated on a center side of the airfoil section than the outer layer section; the orientation angles of the first outer plies include the same values as the orientation angles of the inner plies; and the orientation angles of the second outer plies include values larger than the orientation angles of the first outer plies.

### CROSS REFERENCE TO RELATED APPLICATIONS

This application is a continuation application of International Application No. PCT/JP2024/027566, now WO 2025/109815 A1, filed on August 1, 2024, which claims priority to Japanese Patent Application No. 2023-197277, filed on November 21, 2023, the entire contents of which are incorporated by reference herein.

### TECHNICAL FIELD

The present disclosure relates to a composite blade.

### BACKGROUND ART

Reduction of fuel consumption rate in jet engines is a permanent issue. Against this issue, turbofan engines have been designed to increase the fan diameter to achieve high bypass ratio. However, as the bypass ratio increases, the fan blade becomes larger, which increases the weight of the engine. Therefore, it is required to reduce the weight of fan blades while having high resilience.

A composite blade is a blade including composite plies laminated in a blade thickness direction. Each composite ply is a sheet of carbon fiber reinforced resin (CFRP) in which carbon fibers are used as reinforcing fibers. The plies can reduce weight while providing toughness to the blades. Due to these characteristics, there are increasing opportunities to employ composite blades as fan blades. In this regard, JP 2017-194050 A (Patent Literature) discloses a composite blade developed to suppress strength degradation of the blade root.

### SUMMARY OF THE INVENTION

When a composite blade is manufactured, composite plies having substantially the same shape as the overall shape of the blade surface are often laminated. On the other hand, in order to provide the composite blade with resistance to local impacts such as bird strikes, it is necessary to increase the thickness of the blade. However, when the composite plies having the above-described shape are uniformly laminated, the thickness of a region in which an impact is unlikely to occur also increases, resulting in an excessive increase in the weight of the entire blade.

The present disclosure has been made in view of the above-described circumstances, and it is an object of the present disclosure to provide a composite blade capable of securing impact resistance while suppressing an excessive increase in the weight.

A composite blade according to one aspect of the present disclosure includes: composite plies laminated in a blade thickness direction, having predetermined orientation angles with respect to a span direction, the composite plies constituting an airfoil section of the composite blade; wherein an outer layer section located on an outer layer side of the airfoil section is divided into a first region and a second region which are arranged in the span direction; the composite plies include: first outer plies laminated in the first region; second outer plies laminated in the second region; and inner plies laminated on a center side of the airfoil section relative to the outer layer section; the orientation angles of the first outer plies include the same values as the orientation angles of the inner plies; and the orientation angles of the second outer plies include values larger than the orientation angles of the first outer plies.

According to the present disclosure, it is possible to provide a composite blade which can secure impact resistance while suppressing excessive increase in weight.

### BRIEF DESCRIPTION OF THE DRAWINGS

FIG. 1 is a perspective view illustrating a fan blade which is an example of a composite blade according to an embodiment of the present disclosure.

FIG. 2 is a view illustrating an example of lamination of composite plies.

FIG. 3 is a view illustrating an example of lamination and arrangement of composite plies in an airfoil section.

FIG. 4A is a view illustrating an example of arrangement of a composite ply at a boundary between a first region and a second region.

FIG. 4B is a view illustrating an example of the arrangement of a composite ply at a boundary between a first region and a second region.

### DESCRIPTION OF EMBODIMENTS

Hereinafter, a composite blade according to an embodiment of the present disclosure will be described with reference to the drawings. It should be noted that the same reference numerals are used to denote common portions in each of the drawings, and redundant descriptions thereof will be omitted. For convenience of description, a fan blade 10 will be described as an example of the composite blade according to the embodiment. The fan blade 10 constitutes a fan of an aircraft engine mounted on a turbofan engine (not shown) or the like.

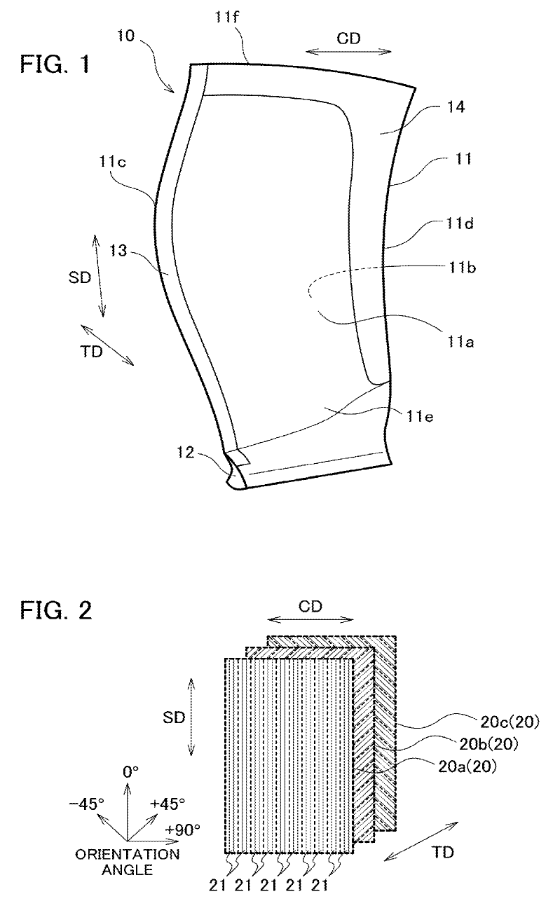

FIG. 1 is a perspective view of the fan blade 10. As shown in FIG. 1, the fan blade 10 includes an airfoil section 11 and a blade root 12. The airfoil section 11 has a suction side 11a, a pressure side 11b, a leading edge 11c, and a trailing edge 11d. The airfoil section 11 extends from the hub 11e to the tip 11f in a span direction SD of the fan blade 10. The blade root 12 is provided on the hub side of the airfoil section 11 and is formed integrally with the airfoil section 11. The blade root 12 is fitted into a mounting groove (not shown) of a rotor (not shown) to which the fan blades 10 are mounted.

Various protective members (not shown) are attached to the airfoil section 11. For example, as shown in FIG. 1, a sheath (cover) 13 is attached to the leading edge 11c by an adhesive. The sheath 13 covers the leading edge 11c and protects the leading edge 11c. A tip cap 14 is provided from the tip 11f to the trailing edge 11d, by the adhesive. The tip cap 14 protects the tip 11f and the trailing edge 11d.

The fan blade 10 includes composite plies 20. The composite plies 20 are fiber reinforced resin (FRP) formed in layers. The composite plies 20 are laminated in the blade thickness direction TD as a main structural material of the fan blade 10. The laminated composite plies 20 constitute at least an airfoil section 11 of the fan blade 10. For example, the composite plies 20 according to the present embodiment constitute the airfoil section 11 and a blade root 12.

The reinforcing fibers of the fiber-reinforced resin according to the present embodiment are carbon fibers. The carbon fibers are bundled in a thread-like manner, uniformly aligned parallel to each other, and aligned in a direction of a predetermined azimuth angle. That is, the composite plies 20 according to the present embodiment are unidirectional carbon fiber-reinforced resin (UDCFRP). However, the reinforcing fibers are not limited to carbon fibers as long as they have the same mechanical strength and flexibility as carbon fibers.

The resin of the fiber-reinforced resin according to the present embodiment is a thermosetting resin or a thermoplastic resin. The thermosetting resin is an epoxy resin, a phenol resin, or a polyimide resin. The thermoplastic resin is a polyetheretherketone or a polyphenylene sulfide. However, the resin components are not limited to the above-mentioned substances.

The blade root 12 is provided with fillers (not shown) in addition to the composite plies 20. The fillers (not shown) are short composite layers formed of the same material as the composite plies 20. By interposing each filler between the composite plies 20, the blade root 12 having a desired cross-sectional shape is formed.

FIG. 2 is a diagram illustrating an example of lamination of the composite plies 20. As shown in FIG. 2, the composite plies 20 are laminated in the blade thickness direction TD. Each composite ply 20 is defined by an orientation angle of reinforcing fibers constituting the composite ply. The orientation angle is an angle defined by the extending direction of the reinforcing fibers with respect to the span direction SD. In other words, the orientation angle of each composite ply 20 means an orientation angle of the reinforcing fibers forming the ply. When comparing orientation angles, their absolute values are used for comparison.

The orientation angle of the laminated composite ply 20 changes periodically. For example, as shown in FIG. 2, the composite ply 20a having an orientation angle of 0°, the composite ply 20b having an orientation angle of +45°, and the composite ply 20c having an orientation angle of -45° are laminated in order. The absolute values of the positive orientation angle and the negative orientation angle may be equal.

Each composite ply 20 is formed by, for example, prepreg tapes 21. In this case, a well-known automatic laminating device (not shown) employing an AFP (Automated Fiber Placement) method is used for forming and laminating each composite ply 20. For example, the automatic laminating device adheres each of the prepreg tapes 21 while curing it to an inner surface (not shown) of a mold having a shape complementary to the shape of the outermost surface 16 of the airfoil section 11.

The prepreg tapes 21 are adhered along a direction defining an orientation angle of the composite ply 20 and arranged in parallel within an area to be the composite ply 20. Here, the prepreg tape 21 is an intermediate material of a composite material in which reinforcing fibers are impregnated with an uncured resin. The reinforcing fibers in the prepreg tapes 21 are aligned in the longitudinal direction of the tapes.

When the automatic laminating device laminates the composite ply 20, it adheres each of the prepreg tapes 21 on the already formed composite ply 20 to form a new composite ply 20. The longitudinal direction (extending direction) of the attached prepreg tapes 21 defines the orientation angle of the composite ply 20.

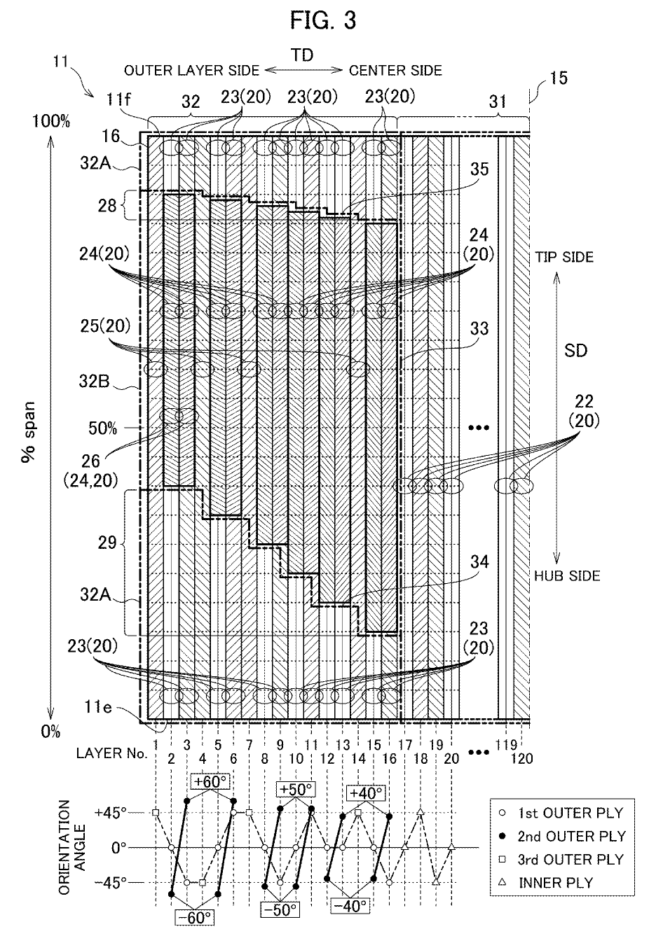

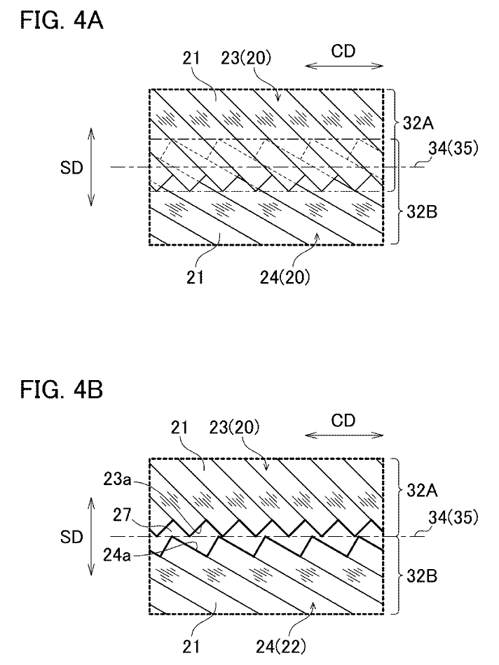

FIG. 3 is a view illustrating an example of lamination and arrangement of the composite plies 20 in the airfoil section 11. FIGS. 4A and 4B are views illustrating examples of arrangement of the composite ply 20 at a boundary 34 (35) between a first region 32A and a second region 32B.

As shown in FIG. 3, the interior of the airfoil section 11 is divided into a core layer section 31 and an outer layer section 32. These sections are arranged in the blade thickness direction TD as laminated regions of the composite plies 20. The outer layer section 32 is set on both sides (i.e. pressure and suction sides of the airfoil section 11) of the core layer section 31 in the blade thickness direction TD. Further, the outer layer section 32 is divided into a first region (first portion) 32A and second regions (second portions) 32B, which are arranged in the span direction SD. That is, the outer layer section 32 is divided into 3 regions along the span direction SD.

The composite plies 20 are laminated in the core layer section 31, the first region 32A of the outer layer section 32, and the second region 32B of the outer layer section 32. Specifically, the composite plies 20 include inner plies 22, first outer plies 23, and second outer plies 24. The inner plies 22 are laminated in the core layer section 31. The first outer plies 23 are laminated in the first region 32A of the outer layer section 32. The second outer plies 24 are laminated in the second region 32B of the outer layer section 32. Although the positions at which they are laminated are different, these plies are made of the same material, and their orientation angles have values corresponding to the respective sections (regions).

The core layer section 31 is located on the center side of the airfoil section 11 in the blade thickness direction TD. The core layer section 31 is distributed from the hub 11e to the tip 11f. The thickness of the core layer section 31 along the blade thickness direction TD accounts for 80% to 90% of the thickness from the center surface 15 to the outermost surface 16 of the airfoil section 11 in the blade thickness direction TD.

As described above, the inner plies 22 are laminated in the core layer section 31. The inner plies 22 extend from the hub 11e to the tip 11f in the airfoil section 11. The inner plies 22 occupy the majority of the members constituting the airfoil section 11 and forms the structural framework of the airfoil section 11. The orientation angle of the inner ply 22 is set to 0°, -45°, or +45° for each ply (see FIG. 2), and plies having different orientation angles are laminated. The plies having an orientation angle of -45° or +45° provide mechanical strength in the chord direction CD that cannot be obtained by only the plies having an orientation angle of 0°.

The outer layer section 32 is located closer to the outer layer side of the airfoil section 11 than the core layer section 31 in the blade thickness direction TD. In other words, the outer layer section 32 is set from the boundary 33 with the core layer section 31 to the outermost surface 16 of the airfoil section 11. Similar to the core layer section 31, the outer layer section 32 extends from the hub 11e to the tip 11f. The thickness of the outer layer section 32 along the blade thickness direction TD is 10% to 20% of the thickness from the center surface 15 to the outermost surface 16 of the airfoil section 11 (i.e., 10% to 20% of the length is half the thickness of the airfoil section 11.).

The first region 32A of the outer layer section 32 is set on both sides (i.e., hub side and tip side) of the second region 32B in the span direction SD. That is, the first region 32A is set in a range from the hub 11e to the boundary 34 with the second region 32B, and in a range from the boundary 35 with the second region 32B to the tip 11f.

The first outer plies 23 are laminated in the first region 32A. The orientation angles of the first outer plies 23 include the same values as the orientation angles of the inner plies 22. The order in which the first outer plies 23 having different orientation angles are laminated is the same as that of the inner plies 22. That is, the orientation angle of each of the first outer plies 23 is also set to 0°, -45°, or +45° (see FIG. 2), and the plies having these different orientation angles are laminated.

The second region 32B of the outer layer section 32 is set between the tip-side first region 32A and the hub-side first region 32A. That is, the second region 32B is set in a range from the boundary 34 to the boundary 35. Thus, the outer layer section 32 is divided into 3 regions along the span direction SD.

The second outer plies 24 are laminated in the second region 32B. The orientation angles of the second outer plies 24 include values larger than those of the first outer plies 23 and the inner plies 22. That is, all of the second outer plies Bmay have orientation angles larger than those of the first outer plies 23 and the inner plies 22. Otherwise, some of the second outer plies 24 may have orientation angles larger than those of the first outer plies 23 and the inner plies 22.

As shown in FIG. 4A, the boundary 34 (35) between the first region 32A and the second region 32B extends generally in the chord direction CD. On the other hand, the prepreg tapes 21 constituting the first outer ply 23 and the second outer ply 24 intersect the chord direction CD at an angle corresponding to the orientation angle of each ply.

When the automatic lamination device is used, the end of each prepreg tape 21 is cut in a direction orthogonal to the extending direction (longitudinal direction) of its prepreg tape 21. Therefore, the edge portion 23a of the first outer ply 23 extends zigzag along the boundary 34 (35). This is also the case for the second outer ply 24.

When the first outer ply 23 and the second outer ply 24 are arranged in the same layer, a state in which they overlap at the boundary 34 (35) (see FIG. 4A) and a state in which they do not overlap (see FIG. 4B) at the boundary 34 (35) are considered. In the latter case, a gap 27 is formed between the edge portion 23a of the first outer ply 23 and the edge portion 24a of the second outer ply 24.

In either of the two cases described above, the boundary 34 (35) between the first region 32A and the second region 32B is shifted in the span direction SD layer by layer. That is, the region in which the first outer ply 23 and the second outer ply 24 overlap is shifted in the span direction SD layer by layer, or the gap 27 between the first outer ply 23 and the second outer ply 24 is shifted in the span direction SD layer by layer. For example, the region or gap 27 described above is alternately located at one and the other of the two locations in the span direction SD. Thus, local increase or decrease of the blade thickness at the boundary 34 (35) can be avoided. Further, since the seams of the first outer ply 23 and the second outer ply 24 are shifted from one layer to another, it is possible to suppress the reduction of strength on the boundary 34 (35) against bending.

Alternatively, the first outer plies 23 and the second outer plies 24 may be laminated so as to alternately repeat the overlapping state and non-overlapping state at the boundary 34 (35). In this case, the positions of the boundaries 34 (35) of the respective layers in the span direction SD may be the same for all layer or may be shifted from layer to layer. In these cases as well, the local increase of the blade thickness at the boundary 34 (35) can be avoided. Furthermore, since the region where the first outer ply 23, the second outer ply 24, or the region where the first outer ply 23 and the second outer ply 24 overlap is located above the gap 27, it is possible to suppress the reduction of the strength at the boundary 34 (35) against bending.

As shown in FIG. 3, the second outer plies 24 may include pairs of plies 26 and 26. Each pair of plies 26 and 26 is laminated in the blade thickness direction TD and has positive and negative orientation angles with equal absolute values. In this case, it is possible to cancel the cross-elasticity effect generated in each pair of plies 26 and 26. For example, uniform bending stiffness can be obtained along the chord direction CD.

As shown in FIG. 3, the composite plies 20 may include at least one third outer ply 25. The third outer ply 25 has a constant orientation angle and extends from the hub 11e of the airfoil section 11 to the tip 11f via the first region 32A and the second region 32B. For example, the third outer ply 25 has an orientation angle of 45° and extends from the hub 11e to the tip 11f. The third outer ply 25 is interposed, for example, between two adjacent first outer plies 23 and between two adjacent second outer plies 24. Thus, the bending rigidity of the outer layer section 32 along the span direction SD can be enhanced.

The third outer ply 25 may be provided as a ply constituting the outermost surface 16 of the airfoil section 11. The third outer ply 25 constituting the outermost surface 16 covers the boundaries 34 and 35 between the first outer ply 23 and the second outer ply 24, and prevents peeling (curling) of the edge portion 23a of the first outer ply 23 (see FIG. 4B) and the edge portion 24a of the second outer ply 24 (see FIG. 4B).

The second region 32B is set at a position relatively susceptible to localized impact from foreign objects. In this regard, the second region 32B is set, for example, near the center (midspan) of the airfoil section 11. As shown in the lower part of FIG. 3, the second outer plies 24 are provided in the second region 32B, and most of the orientation angles of the second outer ply 24 are set to values larger than the orientation angles (absolute values) of the first outer plies 23 provided on both sides of the second outer ply 24 in the span direction SD.

When the foreign object collides with the fan blade 10 rotating at high speed, the collision often occurs at the airfoil section 11. In this case, the collision of the foreign object generates a torsional moment in the airfoil section 11. This torsional moment deforms the airfoil section 11, and induces delamination (inter-ply separation) or crack generation in the airfoil section 11, or peeling or falling off of a protective member such as the sheath 13.

Moreover, the stiffness of the airfoil section against the collision of the foreign object (i.e., localized impact) is more likely to be influenced by the fiber structure on the outer layer side than by the fiber structure on the center side. Therefore, in the present embodiment, the second outer plies 24 are provided in the second region 32B. Most of the orientation angles of the second outer plies 24 are larger than those of the inner plies 22 and the first outer plies 23. That is, the reinforcing fibers in the second region 32B are more inclined (oriented) toward a cross section perpendicular to the span direction SD than the reinforcing fibers in the first region 32A. Further, this cross section is substantially parallel to the main direction of the torsional moment. Therefore, deformation due to the torsional moment is suppressed in the second region 32B. In other words, it is possible to prevent delamination and peeling of the protective member from being induced and improve the impact resistance of the airfoil section 11.

Further, the first outer plies 23, which have the same orientation angles as the inner plies 22, are laminated in the first region 32A. The portion of the airfoil section 11 where the first region 32A is set is a portion where foreign object collisions are relatively few or where the rigidity is relatively high due to positional factors. Therefore, the composite ply 20 (i.e., the first outer ply 23) having the same orientation angle as the inner ply 22 and having high durability against tensile stress caused by centrifugal force is provided without providing the ply having the orientation angle in consideration of the torsional moment described above. Therefore, plies having orientation angles that are set due to the consideration of the above-mentioned torsional moment are not provided, and instead, composite plies 20 (i.e., the first outer plies 23) having the same orientation angles as the inner plies 22 are provided, which have high durability against tensile stress caused by centrifugal force.

As described above, in the present embodiment, the orientation angles of the composite plies 20 in the outer layer section 32 are set in accordance with their positions in the airfoil section 11 along the span direction SD, and the composite plies having the orientation angles are laminated. Therefore, the impact resistance can be secured without excessively increasing the blade thickness or weight.

The orientation angles of the second outer plies 24 may be increased stepwise from the center side to the outer layer side of the airfoil section 11. In other words, the orientation angles of the second outer plies 24 may be decreased stepwise from the outer layer side to the center side of the airfoil section 11. For example, as shown in the lower part of FIG. 3, the absolute values of the orientation angles are set stepwise from the center side to the outer layer side of the airfoil section 11 to 40°, 50°, and 60°. By increasing the orientation angle stepwise, the occurrence of an excessive rigidity difference between the outer layer section 32 and the core layer section 31 and the occurrence of damage such as delamination accompanying the difference can be suppressed. In addition, the stress in the direction perpendicular to the fiber direction (hereinafter, referred to the stress perpendicular to the fiber direction) is dispersed, and the in-plane shear stress is reduced. Thus, the occurrence of resin cracking when foreign objects collide can be suppressed.

The minimum value among the orientation angles (absolute values) of the second outer plies 24 may be smaller than the maximum value among the orientation angles (absolute values) of the inner plies 22. In other words, the minimum value among the angles of the reinforcing fibers of the second outer plies 24 with respect to the span direction SD may be smaller than the maximum value among the angles of the reinforcing fibers of the inner plies 22 with respect to the span direction SD. In this case, for example, as shown in the lower part of FIG. 3, the absolute values of the orientation angles of the two plies closest to the inner plies 22 among the second outer plies 24 are set to, for example, 40°.

When the orientation angles of the second outer plies 24 are decreased stepwise from the outer layer side to the center side of the airfoil section 11, the orientation angles of the second outer plies 24 approaches ±45°, which is the orientation angle of the inner plies 22, as they become closer to the core layer section 31. Here, it should be noted that, when composite plies having the same orientation angle are laminated to each other, the stress perpendicular to the fiber direction and the in-plane shear stress tend to increase. Therefore, in the present embodiment, the absolute value of the orientation angle of the second outer ply 24 close to the center side is set to a value smaller than 45° in order to improve the strength along the span direction SD in the outer layer section 32 while avoiding the value from being close to the inner ply 22 having the orientation angle of ±45°. By such setting of the orientation angle, the occurrence of both fiber breakage and resin cracking in the outer layer section 32 near the boundary with the core layer section 31 can be suppressed.

The second outer plies 24 may be arranged so as to stepwise approach the tip 11f of the airfoil section 11 and stepwise move away from the hub 11e of the airfoil section 11 as they approach the outer layer of the airfoil section 11. For example, as shown in the lower part of FIG. 3, the orientation angle of the second outer ply 24 is gradually increased from 40° to 60°, and the larger the orientation angle, the closer it is to the tip 11f. Thus, the transition portion 28 on the tip side is formed. The orientation angle of the second outer ply 24 is gradually increased from 40° to 60°, and the larger the orientation angle, the further it is from the hub 11e. Thus, the transition portion 29 on the hub side is formed.

By providing the transition portion 28 on the tip side, the first outer plies 23 including the composite ply 20 with an orientation angle of 0° and the second outer plies 24 having orientation angles larger than those of the first outer plies 23 coexist within the same range in the span direction SD.

The composite ply 20 with an orientation angle of 0°, which is the first outer ply 23, can suppress the deformation of the airfoil section 11 on the tip side due to the bending moment caused by the load in the span direction SD when a foreign object collides, and can suppress the occurrence of damage such as delamination on the tip side due to the bending moment. On the other hand, in the transition portion 28, the proportion of the second outer plies 24 having relatively large orientation angles among the orientation angles set in the second outer plies 24 is high. The second outer plies 24 having relatively large orientation angles suppress the deformation of the airfoil section 11 due to the above-mentioned torsion moment and the bending of the airfoil section 11 caused by the load in the chord direction CD, thereby suppressing the occurrence of damage such as delamination starting from the foreign object impact point. That is, the tip side portion of the airfoil section 11 is likely to be twisted in the chord direction CD due to the collision of the foreign object and the bending of the airfoil section 11 caused by the load in the chord direction CD. Here, there is a high concern about damage due to the latter bending. The second outer plies 24 having relatively large orientation angles suppress the twisting and bending of the airfoil section 11 as described above.

Similar to the transition portion 28 on the tip side, the first outer plies 23 and the second outer plies 24 coexist in the same range in the span direction SD in the transition portion 29 on the hub side. Therefore, the composite ply 20 having an orientation angle of 0°, which is the first outer ply 23 in the transition portion 29, suppresses the deformation of the airfoil section 11 due to the bending moment generated when the foreign object collides, and suppresses the occurrence of damage such as delamination on the hub side due to the bending moment.

In the transition portion 29, the proportion of the second outer plies 24 having relatively small orientation angles is high among the orientation angles set in the second outer plies 24. When a bending moment caused by a load in the span direction SD occurs in the airfoil section 11, the internal stress (bending stress) caused by the moment is larger in the transition portion 29 on the hub side than in the transition portion 28 on the tip side. Therefore, in the transition portion 29, the proportion of the second outer plies 24 having relatively small orientation angles (i.e., those with a greater tendency to orient in the span direction SD) is increased.

Thus, the second outer ply 24 in the transition portion 29, together with the first outer ply 23 on the hub side, suppresses the deformation of the airfoil section 11 on the hub side due to the bending moment caused by the bending with respect to the span direction SD at the time of collision of the foreign object.

The second region 32B may be set from the boundary 34 with the first region 32A set on the hub side to the tip 11f of the airfoil section 11. That is, the outer layer section 32 may be divided into two regions. In this case, it is possible to extend the range for suppressing excessive distortion of the airfoil section 11, which is curved along the chord direction CD, to the tip side. Furthermore, the composite plies 20 in the outer layer section 32 can be laminated manually without using an automatic lamination device.

It should be noted that the present disclosure is not limited to the above-described embodiments, but is shown by the description of the claims, and further includes the meaning of the description of the claims and all changes within the scope.

What is claimed is:

1. A composite blade, comprising:
composite plies laminated in a blade thickness direction, having predetermined orientation angles with respect to a span direction, the composite plies constituting an airfoil section of the composite blade; wherein
an outer layer section located on an outer layer side of the airfoil section is divided into a first region and a second region which are arranged in the span direction;
the composite plies include:
first outer plies laminated in the first region;
second outer plies laminated in the second region; and
inner plies laminated on a center side of the airfoil section relative to the outer layer section;
the orientation angles of the first outer plies include the same values as the orientation angles of the inner plies; and
the orientation angles of the second outer plies include values larger than the orientation angles of the first outer plies.

2. The composite blade according to claim 1, wherein
the orientation angles of the second outer plies increase stepwise from the center side of the airfoil section to the outer layer side of the airfoil section.

3. The composite blade according to claim 2, wherein
the second outer plies are arranged so as to stepwise approach a tip of the airfoil section and stepwise move away from a hub of the airfoil section as the second outer plies approach the outer layer of the airfoil section.

4. The composite blade according to claim 2, wherein
a minimum value among the orientation angles of the second outer plies is smaller than a maximum value among the orientation angles of the inner plies.

5. The composite blade according to claim 1, wherein
the second outer plies include pairs of plies laminated in the blade thickness direction and having positive and negative orientation angles with equal absolute values.

6. The composite blade according to claim 1, wherein
the boundary between the first region and the second region is shifted in the span direction layer by layer.

7. The composite blade according to claim 1, wherein
the first outer plies and the second outer plies are laminated so as to alternately repeat an overlapping state and a non-overlapping state.

8. The composite blade according to claim 1, wherein
the first region is set on both sides of the second region in the span direction.

9. The composite blade according to claim 1, wherein
the second region is set from a boundary with the first region to a tip of the airfoil section.

10. The composite blade according to claim 1, wherein
the composite plies include at least one third outer ply having a constant orientation section angle and extending from a hub of the airfoil section to a tip of the airfoil section via the first region and the second region.

11. The composite blade according to claim 1, wherein
each of the composite plies is formed by prepreg tapes of composite material extending at an orientation angle thereof and arranged in parallel.
